(19) United States
(12) Patent Application Publication
(10) Pub. No.: US 2007/0255846 A1
(43) Pub. Date: Nov. 1, 2007

(54) Distributed storage of media data

(76) Inventors: Susie J. Wee, Palo Alto, CA (US); John G. Apostolopoulos, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/413,992

(22) Filed: Apr. 28, 2006

(51) Int. Cl. G06F 15/16

(52) U.S. Cl. 709/231

(57) ABSTRACT

Methods and systems thereof for storing a stream of media data are described. The media data describes an instance of media content. The media data can be scalably encoded. The scalably encoded data is separated into at least a first portion and a second portion. The first portion of scalably encoded data is stored on a first node in a network. The second portion of scalably encoded data is stored on a second node in the network.

### TECHNICAL FIELD

Embodiments of the present invention relate to the field of streaming media data.

### BACKGROUND ART

Networked streaming environments present many challenges for the system designer. For instance, clients can have different display, power, communication, and computational capabilities. In addition, communication links (wired or wireless) can have different maximum bandwidths, quality levels, and time-varying characteristics. A successful streaming system is capable of streaming content to heterogeneous clients over time-varying communication links. In some instances, maintaining the security of the content is also important.

One means for achieving scalability and efficiency in streaming environments is to adapt or transcode a compressed (encoded) stream at intermediate network nodes. A transcoder takes a compressed stream as input, and then processes it to produce another compressed stream as the output. Sample transcoding operations include bitrate reduction, rate shaping, spatial downsampling, frame rate reduction, and changing compression formats. Network transcoding can improve system scalability and efficiency, for example, by adapting the spatial resolution of a stream for a particular client's capabilities or by dynamically adjusting the bitrate of a stream to match a network channel's time-varying characteristics.

While network transcoding facilitates scalability in streaming systems, it also presents a number of challenges. First, while computationally efficient transcoding algorithms have been developed, even those are not well-suited for processing hundreds or thousands of streams at intermediate network nodes or even a few streams at intermediate low-power networking relay nodes. Furthermore, conventional network transcoding poses a serious threat to the security of the streaming system because conventional transcoding operations performed on encrypted streams generally require decrypting the stream, transcoding the decrypted stream, and then re-encrypting the result. Because conventionally every transcoder must decrypt the stream, each network transcoding node presents a possible breach in the security of the entire system.

As yet another concern, networked streaming systems are limited by wired/wireless bandwidth and client resources. Wireless bandwidth is scarce because of its shared nature and the fundamental limitations of the wireless spectrum. Wired bandwidth is limited by its shared nature, which can result in network congestion. Client resources are often practically limited by power constraints and by display, communication, and computational capabilities. As an example, wireless transmission and even wireless reception alone typically consume large power budgets. In order to make the most efficient use of network bandwidth and client resources, it is desirable to send clients the lowest bandwidth streams that match their display, processing and communication capabilities. In networked streaming systems where a sender streams content to a number of heterogeneous clients with different resources, network transcoders can be used to help achieve end-to-end system efficiency and scalability.

In hybrid wired/wireless networks, it is often necessary to simultaneously stream content to fixed clients on a wired network and to mobile clients on a wireless network. In such a hybrid system, it may often be desirable to send a full-bandwidth, high-resolution stream to a fixed wired client, and a lower-bandwidth, medium-resolution stream to a mobile wireless receiver. Conventional streaming approaches, however, do not achieve the efficiency, security, and scalability necessary to readily accommodate the video streaming corresponding to hybrid wired/wireless networks.

Accordingly, a method and/or system that can allow media data to be streamed and/or stored in a secure and/or computationally efficient manner would be advantageous. A method and/or system that can also allow media data to be streamed to heterogeneous clients that may have different display, power, communication and computational capabilities and characteristics would also be advantageous. Conventional solutions are either lacking in one or more of these capabilities, or are unduly complex.

### DISCLOSURE OF THE INVENTION

Embodiments of the present invention pertain to methods and systems thereof for storing and distributing a stream of media data. In one embodiment, the media data describes an instance of media content and is scalably encoded. In such an embodiment, the scalably encoded data is separated into a first portion and a second portion. The first portion of scalably encoded data is stored on a first node in a network. The second portion of scalably encoded data is stored on a second node in the network.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates scalable encoding of a media stream in one embodiment in accordance with the present invention.

FIG. 2 is a block diagram showing elements of a network upon which embodiments in accordance with the present invention may be implemented.

FIG. 3 is a flowchart of a method for storing a stream of media data in accordance with an embodiment of the present invention.

FIG. 4 is a flowchart of a method for streaming media data in accordance with an embodiment of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

The descriptions and examples provided herein are discussed in the context of multimedia data (also referred to herein as media data or media content). One example of multimedia data is video data accompanied by audio data; for example, a movie with soundtrack. However, media data can be video only, audio only, or both video and audio. In general, the present invention, in its various embodiments, is well-suited for use with speech-based data, audio-based data, image-based data, Web page-based data, graphic data and the like, and combinations thereof.

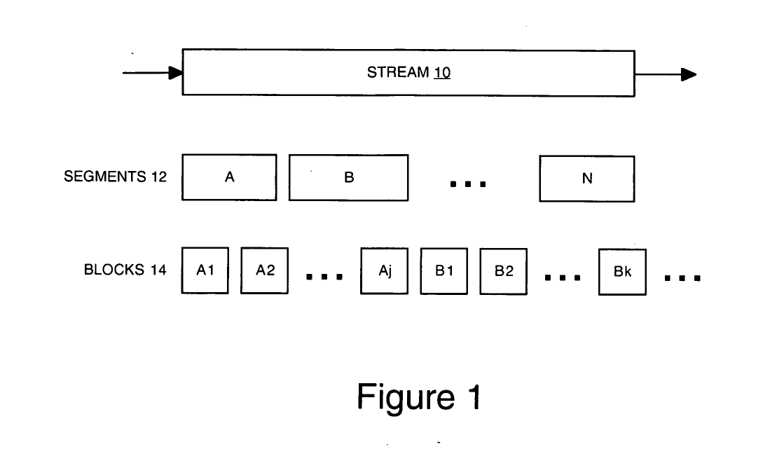

FIG. 1 illustrates scalable encoding of a media stream 10 in an embodiment in accordance with the present invention. Media stream 10 includes media data for an instance of media content. An instance of media content may include an item such as a movie or a live event that has been captured and recorded, or a live event that is to be distributed in real time. One instance of media content may be differentiated from another. For example, a first instance of media content may have one title and a second instance of media content may have a different title. In one embodiment, an instance of media content refers to an instance of original data that can be separated into segments and blocks as will be seen, where the segments and blocks can be reassembled by a decoding device into some form of the original data, where the original data represents content that includes a sequence of related pictures with a start point and an end point, and where there may be a time-wise dependence of the content between the start point and end point.

More specifically, in one embodiment, the output of an encoder is referred to as an elementary stream. Packets in the same elementary stream have the same packet identifier code (PID). Thus, in one embodiment, an instance of media content is identified as such using the PID—an instance of media content has its own PID.

An instance of media content may be identified using an object descriptor (OD)—an instance of media content has its own OD identifier. The OD may point to a list of elementary stream descriptors that point to one or more streams with data or side information for the instance of media content.

An instance of media content may be identified using an intellectual property identification (IPI) descriptor—an instance of media content has its own IPI descriptor. If multiple instances of media content are identified by the same IPI information, the IPI descriptor may consist of a pointer to another elementary stream or PID.

An instance of media content may be identified by its own Uniform Resource Locator (URL).

There may be other ways to distinguish one instance of media content from another.

Stream 10 can be separated into a number of data segments 12 A, B, . . . , N. The segments 12 A, B, . . . , N can be intelligently selected based on the content of the stream 10. For example, a segment may correspond to an image frame or to a particular region within an image frame. The segments can have different sizes.

Each respective segment 12 A, B, . . . , N is scalably encoded as data blocks 14 A1, A2, . . . , Aj, B1, B2, . . . , Bk, etc. The data blocks can have different sizes. Furthermore, the data blocks may be scalable at a finer granularity as well, where a data block may be partially decodable. Scalable coding standards include, but are not limited to, Moving Pictures Experts Group (MPEG) 1/2/4 and H.26112/3/4, JPEG (Joint Photographic Experts Group) 2000 including Motion JPEG 2000, and 3-D subband coding for images and video. Scalable coding methods also exist for speech, audio, Web-based and graphics data.

Scalably encoded data has the property that portions of the encoded data can be used to reconstruct the original data with various quality levels. Specifically, the scalably encoded data can be thought of as an embedded bitstream. A portion of the bitstream can be used to decode a baseline-quality reconstruction of the original data, without requiring any information from the remainder of the bitstream, and progressively larger portions of the bitstream can be used to decode improved reconstructions of the original data.

For example, if an image is scalably encoded by resolution, then a small portion of the data can be decoded and used to reconstruct a low-resolution image, a larger portion of the data can be decoded and used to reconstruct a medium-resolution image, and all of the data can be decoded and used to reconstruct a full-resolution image. Thus, for example, block A1 can be decoded and used to reconstruct a low-resolution image of an instance of media content, block A2 can be decoded and used in combination with the decoded data from block A1 to reconstruct a higher (but still relatively low) resolution image of the instance of media content, and so on, with block Aj being decoded and used with the other blocks A1, A2, . . . to reconstruct the highest resolution image of the instance of media content. As will be described, according to embodiments of the present invention, each of the blocks 14 of the instance of media content is distributed to one or more network nodes for storage, and then subsequently delivered from their respective storage nodes to a destination client device for decoding.

In one embodiment, the scalably encoded data is encrypted. In such an embodiment, the original data (plaintext) is encrypted into encrypted data (ciphertext). Encryption techniques such as, but not limited to, block ciphers and stream ciphers can be used. The encryption operation may be performed across the entire media stream, or it may be performed on segments of the media stream.

In another embodiment, the scalably encoded data is progressively encrypted. As used herein, progressive encryption is defined as a process that takes original data (plaintext) as input and creates progressively encrypted data (ciphertext) as output. Progressive encryption techniques include, but are not limited to, cipher block chains and stream ciphers. These progressive encryption methods have the property that the first portion of the data is encrypted independently, and later portions are encrypted based on earlier portions. The plaintext is encrypted in a beginning-to-end or sequential manner, wherein a first portion of the bitstream is encrypted by itself, a second portion of the bitstream is encrypted using (e.g., in combination with) the first portion (either the encrypted or the unencrypted first portion may be used), and so on. Progressively encrypted data has the property that the first portion can be decrypted alone, without requiring information from the remainder of the original data; and progressively larger portions can be decrypted with this same property, in which decryption can use data from earlier but not later portions of the bitstream. Progressive encryption standards include, but are not limited to, the Data Encryption Standard (DES), Triple-DES, and the Advanced Encryption Standard (AES). These encryption primitives can be applied using a number of block-cipher modes including electronic codebook (ECB), cipher block chaining (CBC), cipher-feedback (CFB), output feedback (OFB), and counter (CTR) modes.

Along with progressive encryption, authentication techniques that may be used include, but are not limited to, popular authentication techniques such as message authentication codes (MACs) and digital signatures (DSs). Popular MACs include hash-based MACs such as Hashed Message Authentication Code (HMAC) using the Secure Hash Algorithm-1 (SHA-1) hash, or cipher-based MACs such as AES in CBC mode. Data packets can be independently authenticated so that one or more packets can be discarded without affecting the ability to authenticate other packets. Alternatively, groups of packets can be independently authenticated, so that groups of packets can be discarded without affecting the ability to authenticate other groups of packets. The above cryptographic techniques may be applied using symmetric key techniques or using public/private key techniques.

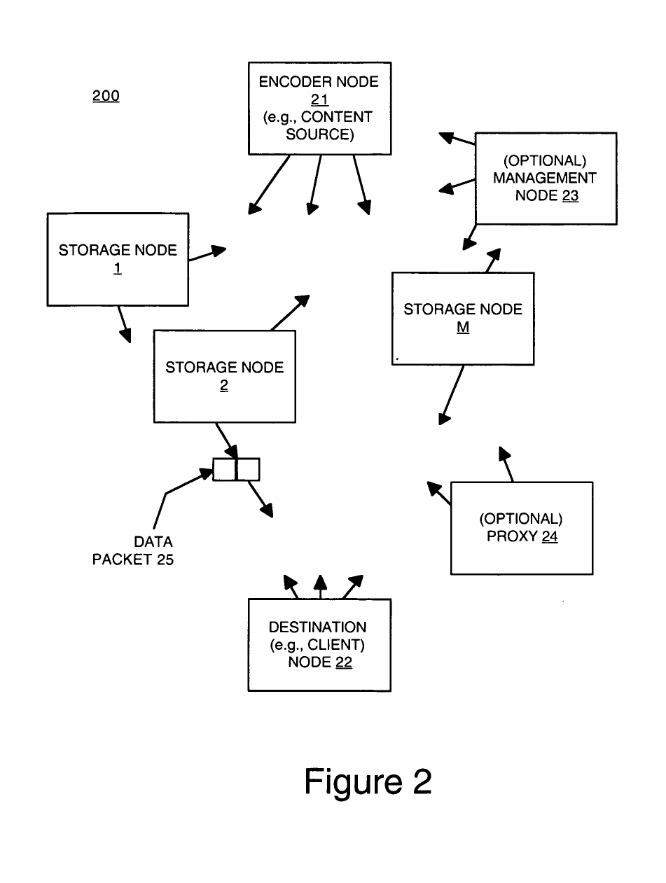

FIG. 2 is a block diagram showing elements of a network 200 upon which embodiments in accordance with the present invention may be implemented. In the example of FIG. 2, network 200 includes an encoder node 21 for encoding (specifically, scalably encoding) an item of media content, as described in conjunction with FIG. 1, for example. Encoder node 21 may also encrypt (specifically, progressively encrypt) the scalably encoded data. Encoder node 21 may receive the item of media content from another node (not shown), or encoder node 21 may itself be the content source. Although a single encoder node 21 is illustrated, there may be more than one encoder node.

In the present embodiment, network 200 of FIG. 2 includes a number of nodes 1, 2, . . . , M, each of which has the capability to store scalably encoded data received from encoder node 21. As mentioned above, the data may also be encrypted or progressively encrypted. Encoder node 21 may communicate with the nodes 1, 2, . . . , M via a wired or wireless connection. Nodes 1, 2, . . . , M may or may not communicate with each other. Although described as storage nodes, nodes 1, 2, . . . , M may have additional functionality, such as transcoding capability or the capability to packetize the scalably encoded data into data packets.

In one embodiment, network 200 includes an optional management node 23. Management node 23, in general, has knowledge of what information is stored on each of the nodes 1, 2, . . . , M. Management node 23 can direct traffic (e.g., data packets or blocks of encoded data) from encoder node 21 to the various storage nodes 1, 2, . . . , M, and from the storage nodes 1, 2, . . . , M to a subsequent destination (e.g., client or decoder node 22). The functionality provided by management node 23 may instead be incorporated into the encoder node 21 or any of the storage nodes 1, 2, . . . , M, or distributed across those nodes. For example, the storage nodes 1, 2, . . . , M may make decisions amongst themselves with regard to how to distribute information between the storage nodes, as well as decisions about which of the storage node(s) will respond to client requests.

Client node 22 is a mobile or stationary device coupled to the network 200 via a wired or wireless connection. There may be more than one client or decoder node in communication with network 200, and the number of client/decoder nodes will typically change with time.

In one embodiment, network 200 includes an optional proxy 24. In such an embodiment, client node 22 communicates a request for an item of content to proxy 24, which in turn acts on behalf of client node 22 and retrieves information from storage nodes 1, 2, . . . , M and delivers the retrieved information to client node 22, or directs the information from storage nodes 1, 2, . . . , M to client node 22.

In another embodiment, client node 22 communicates directly with each of the storage nodes 1, 2, . . . , M to request and retrieve information for an item of content.

In overview, with reference to FIGS. 1 and 2, data for an item of media content is distributed and stored in network 200 as follows. A stream 10 of data that represents the item of media content is scalably encoded into segments 12 and/or blocks 14. The segments 12 and blocks 14 may also be progressively encrypted.

In one embodiment, the segments 12 are distributed to one or more of the storage nodes 1, 2, . . . , M. That is, for example, segment A may be sent to storage node 1, segment B to storage node 2, and so on. More than one segment may be sent to each of the storage nodes; that is, for example, segments A and B can both be sent to storage node 1. Also, a segment can be sent to more than one storage node; that is, for example, segment A can be sent to both storage node 1 and storage node 2.

In one embodiment, the blocks 14 are distributed to one or more of the storage nodes 1, 2, . . . , M. That is, for example, block A1 may be sent to storage node 1, block A2 to storage node 2, and so on. More than one block may be sent to each of the storage nodes; that is, for example, blocks A1 and A2 can both be sent to storage node 1. Also, a block can be sent to more than one storage node; that is, for example, block A1 can be sent to both storage node 1 and storage node 2. Furthermore, blocks 14 can be sent to the storage nodes irrespective of the segments 12 with which the blocks are associated; that is, for example, blocks A1 and B1 can be sent to storage node 1. Moreover, blocks 14 can be sent to the various storage nodes in any combination. For example, if the item of content is encoded according to resolution level, a block corresponding to the lowest resolution level and a block corresponding to another resolution level can be sent to the same storage node; that is, blocks A1 and B2 can be sent to storage node 1.

The distribution of segments 12 and/or blocks 14 to the various storage nodes 1, 2, . . . , M is governed by the nature of the information contained within each of the segments 12 or blocks 14, the network conditions between encoder node 21 and storage nodes 1, 2, . . . , M, the anticipated network conditions between storage nodes 1, 2, . . . , M, and the anticipated number and types of client or destination nodes. There are a number of examples that can be used to illustrate the variety of patterns for distributing the segments 12 and/or blocks 14 amongst the storage nodes 1, 2, . . . , M. The examples below are not intended to limit the breadth and scope of the invention, but rather to illustrate that variety.

For example, scalably encoded data used for baseline-quality reconstruction of an item of media content (e.g., the blocks A1, B1, etc.) is typically considered to be of higher priority than other blocks (e.g., A2, B2, etc.), because the baseline blocks are used as foundations by the other blocks; that is, when reconstructing an image, block A2 can depend on the data in block A1 but not vice versa. Thus, when considering how scalably encoded data is to be distributed amongst the storage nodes 1, 2, . . . , M, a decision may be made to store the baseline blocks (e.g., A1, B1, etc.) on a more reliable node. Also, because the baseline blocks will typically be used by all client devices, a decision may be made to store the baseline blocks on multiple nodes and/or on higher capacity nodes. Similarly, if a particular storage node generally serves only client devices that utilize, for example, the lowest resolution image data only, then a decision may be made to not store other than the baseline blocks at that node.

Other types of information that can be considered when making decisions on how to distribute scalably encoded data include, but are not limited to: bandwidth available along paths in the network; bottleneck link capacity along paths in the network; data packet delivery rates along paths in the network; data packet loss rates along paths in the network; data packet received patterns along paths in the network; data packet loss patterns along paths in the network; information quantifying time needed to traverse paths in the network; information quantifying delays associated with paths in the network; information quantifying proximity to network clients; information quantifying the number of network clients served by respective nodes in the network; distance of the storage nodes in relation to one another (for security reasons, for example, it may be better to have the nodes on which the data is stored physically separated by large distances); and information identifying characteristics of network clients served by respective nodes in the network.

Network conditions, such as those listed above, can vary with time. Accordingly, the distribution of the segments 12 and/or blocks 14 can change with time. That is, for example, after the segments 12 and/or blocks 14 associated with a particular item of media content have been initially distributed amongst the storage nodes 1, 2, . . . , M, they may be redistributed amongst the storage nodes as network conditions, including the distribution of client nodes, change. In other words, the distribution of the segments 12 and/or blocks 14 can be changed as network conditions change, as the demand for a particular item of media content increases or decreases, and as the number and location of each type of client node changes.

In the example above, information about the data itself is also a factor in considering how the data is to be distributed amongst the storage nodes 1, 2, . . . , M. Information about the data includes, but is not limited to: spatial area features of the scalably encoded data; color component features of the scalably encoded data; resolution levels of the scalably encoded data; quality levels of the scalably encoded data; rate distortion information about the scalably encoded data; security sensitivity of the scalably encoded data; time delivery requirements of the scalably encoded data; coding dependencies of the scalably encoded data; and encryption dependencies of the scalably encoded data.

In the case of security, data may be distributed in a manner that increases the security of the media data by storing related scalable segments at different nodes. For example, different quality levels or resolution levels corresponding to a single portion of an image may be stored on different nodes to increase the security of the system.

In one embodiment, in response to a request from client node 22 for the item of content, the various components associated with the item of content (e.g., the segments 12 or blocks 14) are streamed from the storage node on which they are respectively stored to client node 22 (perhaps via proxy 24). That is, the segments 12 A, B, . . . , N or blocks 14 A1, A2, . . . , Aj, B1, B2, . . . , Bk, . . . are delivered to client node 22 from the storage nodes 1, 2, . . . , M on which they are stored. Importantly, if the segments or blocks are encrypted, they can be located on the storage nodes 1, 2, . . . , M and delivered to client node 22 while still encrypted.

In one embodiment, the storage nodes 1, 2, . . . , M packetize the data as scalable data packets (e.g., data packet 25). The data constituting each data packet 25 is a function of the data stored on the storage node. Thus, a data packet may include data from multiple non-overlapping segments of the stream 10. That is, for example, data packet 25 may include blocks A1 and B1, or blocks A1 and B2, or the like.

One useful form of transcoding involves the truncation of data packets, in which the data is arranged in a data packet so that data for a first resolution level, for example, is located in a first portion of the packet, data for a second resolution level is located in a second portion of the packet, and data for a third resolution is located in a third portion, where the second portion is located between the first and third portions, so that if an image is to be reconstructed at, for example, only the first resolution level, then during transcoding the second and third portions can be truncated, leaving a smaller packet consisting of only the first portion. If, according to embodiments of the present invention, only baseline-quality data (e.g., blocks A1, B1, etc.) is stored on a storage node, for example, then data packet 25 of FIG. 2 can include some portion of those blocks (e.g., A1 and B1), another data packet can include another portion of those blocks, and so on. Thus, by intelligently selecting how the scalably encoded data is distributed amongst the storage nodes 1, 2, . . . , M, an equivalent to transcoding by truncation can be effected.

For example, during transcoding by truncation, a data packet that includes blocks A1, A2 and A3 may be truncated to remove blocks A2 and A3, a data packet that includes blocks B1, B2 and B3 may be truncated to remove blocks B2 and B3, and the remaining blocks A1 and B1 may be re-packetized into a data packet that includes blocks A1 and B1. According to embodiments of the present invention, the same result can be achieved by, in essence, building a data packet that initially includes only blocks A1 and B1.

Another useful form of transcoding involves the extraction of data from within a data packet, and then re-packetizing the extracted data. Again, by intelligent distribution of the segments 12 and/or blocks 14 amongst the storage nodes 1, 2, . . . , M, an equivalent form of transcoding is achieved by, in essence, building a data packet that initially includes only the data of interest. For example, during transcoding by extraction, a data packet that includes blocks A1, A2 and A3 may be transcoded to extract block A2, a data packet that includes blocks B1, B2 and B3 may be transcoded to extract block B3, and blocks A2 and B3 may be re-packetized into a data packet. According to embodiments of the present invention, the same result can be achieved by, in essence, building a data packet that initially includes only A2 and B3.

In general, instead of transcoding data packets to remove some data while retaining data of interest, embodiments in accordance with the present invention can achieve essentially the same result by building data packets that initially include just the data of interest. Importantly, this can be accomplished while the data remains encrypted, thus maintaining the security of the content in those instances where security is a consideration.

If a segment or block is stored on more than one storage node, one of the storage nodes is selected to deliver the segment or block, depending on, for example, network conditions between the storage nodes and the client node 22, including conditions on the storage nodes themselves. As mentioned above, network conditions can include, but are not limited to: bandwidth available along paths in the network; bottleneck link capacity along paths in the network; data packet delivery rates along paths in the network; data packet loss rates along paths in the network; data packet received patterns along paths in the network; data packet loss patterns along paths in the network; information quantifying time needed to traverse paths in the network; information quantifying delays associated with paths in the network; information quantifying proximity to network clients; information quantifying the number of network clients served by respective nodes in the network; distance of the storage nodes in relation to one another (for security reasons, for example, it may be better to have the nodes on which the data is stored physically separated by large distances); and information identifying characteristics of network clients served by respective nodes in the network.

As mentioned above, in various embodiments, the request is fulfilled either under control of client node 22, management node 23, proxy 24, the storage nodes 1, 2, . . . , M, or some combination thereof. In a client-driven approach, client node 22 can communicate directly with each of the storage nodes 1, 2, . . . , M. In essence, the intelligence for fulfilling a request for an item of content resides on the client node 22, which accesses the various storage nodes 1, 2, . . . , M as needed to locate the data needed for reconstructing the item of content. In a proxy-controlled approach, the client node 22 identifies an item of content to proxy 24, which provides the intelligence for fulfilling the request by accessing the various storage nodes 1, 2, . . . , M as needed to locate the data associated with the item of content and by forwarding that data to the client node 22 (or by directing the storage nodes to forward that data directly to the client node). A centrally managed approach, under control of management node 23, operates in a similar manner to fulfill a request. In any of these approaches, the storage nodes 1, 2, . . . , M can be relatively simple storage devices; that is, they do not require extensive computational capabilities.

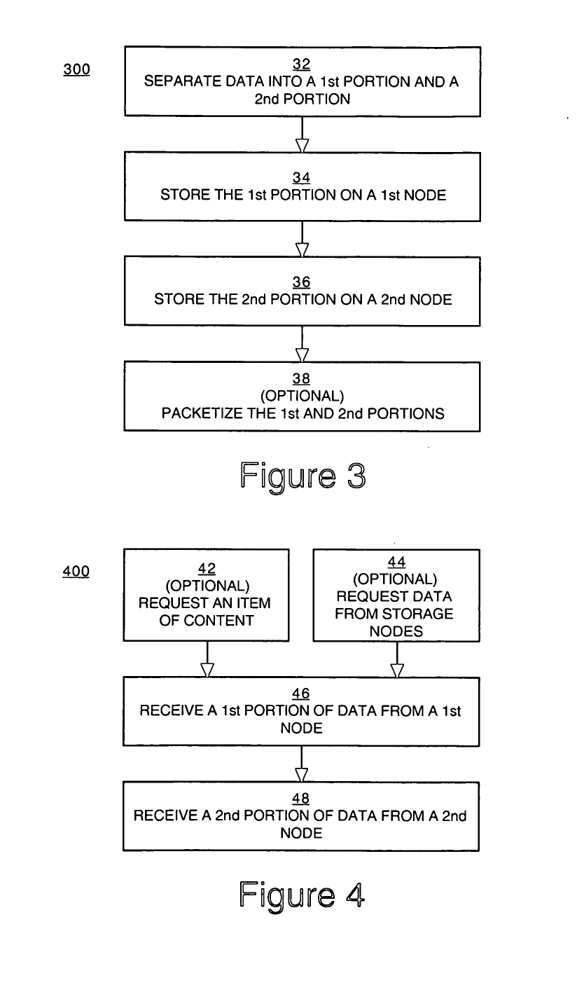

FIG. 3 is a flowchart 300 of a method for storing a stream of media data in accordance with an embodiment of the present invention. FIG. 4 is a flowchart 400 of a method for streaming media data in accordance with an embodiment of the present invention. Although specific steps are disclosed in flowcharts 300 and 400, such steps are exemplary. That is, embodiments of the present invention are well-suited to performing various other steps or variations of the steps recited in flowcharts 300 and 400. It is appreciated that the steps in flowcharts 300 and 400 may be performed in an order different than presented, and that not all of the steps in flowcharts 300 and 400 may be performed. All of, or a portion of, the methods described by flowcharts 300 and 400 may be implemented using computer-readable and computer-executable instructions which reside, for example, in computer-usable media of a computer system.

In block 32 of FIG. 3, scalably encoded data representing an item of media content is separated into at least a first portion and a second portion (e.g., by encoding node 21 of FIG. 2). The data may also be encrypted or progressively encrypted. With reference also to FIG. 1, in one embodiment, the first portion includes data from a first segment (e.g., segment 12 A) of a stream 10 and the second portion includes data from a second segment (e.g., segment 12 B) of the stream 10. In another embodiment, the first portion includes a first block of data (e.g., block 14 A1) and the second portion comprises a second block of data (e.g., block 14 A2, or block 14 B1, etc.).

In one embodiment, the first and second portions are selected according to information about the scalably encoded data, such as but not limited to: spatial area features of the scalably encoded data; color component features of the scalably encoded data; resolution levels of the scalably encoded data; quality levels of the scalably encoded data; rate distortion information about the scalably encoded data; security sensitivity of the scalably encoded data; time delivery requirements of the scalably encoded data; coding dependencies of the scalably encoded data; and encryption dependencies of the scalably encoded data.

In the case of security, data may be distributed in a manner that increases the security of the media data by storing related scalable segments at different nodes. For example, different quality levels or resolution levels corresponding to a single portion of an image may be stored on different nodes to increase the security of the system.

In block 34 of FIG. 3, with reference also to FIG. 2, the first portion of the scalably encoded data is stored on a first node (e.g., storage node 1) in a network 200.

In block 36 of FIG. 3, with reference also to FIG. 2, the second portion of the scalably encoded data is stored on a second node (e.g., storage node 2) in the network 200.

In one embodiment, the first and second nodes are selected according to information about the network, such as but not limited to: bandwidth available along paths in the network; bottleneck link capacity along paths in the network; data packet delivery rates along paths in the network; data packet loss rates along paths in the network; data packet received patterns along paths in the network; data packet loss patterns along paths in the network; information quantifying time needed to traverse paths in the network; information quantifying delays associated with paths in the network; information quantifying proximity to network clients; information quantifying the number of network clients served by respective nodes in the network; and information identifying characteristics of network clients served by respective nodes in the network.

In block 38 of FIG. 3, in one embodiment, the first and second portions are packetized into scalable data packets at their respective storage nodes.

With reference now to block 42 of FIG. 4, in one embodiment (e.g., in a proxy-driven or centrally managed approach), client node 22 (FIG. 2) makes a request for an instance of media content.

In another embodiment (e.g., a client-driven approach), in block 44 of FIG. 4, client node 22 (FIG. 2) requests data from certain storage nodes known to the client as having data for the instance of media content (e.g., storage nodes 1, 2, . . . , M of FIG. 2).

In block 46 of FIG. 4, the client receives a first portion of scalably encoded data for the instance of media content from a first storage node (e.g., storage node 1 of FIG. 2).

In block 48 of FIG. 4, the client receives a second portion of scalably encoded data for the same instance of media content from a second storage node (e.g., storage node 2 of FIG. 2). The first and/or second portions of the scalably encoded data may also be progressively encrypted.

With reference also to FIG. 1, in one embodiment, the first portion includes data from a first segment (e.g., segment 12 A) of a stream 10 and the second portion includes data from a second segment (e.g., segment 12 B) of the stream 10. In another embodiment, the first portion includes a first block of data (e.g., block 14 A1) and the second portion comprises a second block of data (e.g., block 14 A2, or block 14 B1, etc.).

In summary, in its various embodiments, the present invention provides methods and systems for storing and distributing streams of media data. In general, a stream is separated into multiple portions, and the portions are stored on different storage nodes in a network. Thus, the stream is not stored on a single server, providing a number of advantages such as greater fault tolerance and security. Furthermore, because the content is distributed, it can be streamed to a client along different paths through the network, which also provides greater fault tolerance and security.

Fault tolerance is improved because, for example, if a server should fail or if a network path is congested, at least some amount of media data is expected to reach the client, from those servers (e.g., storage nodes) still in service and along alternate paths that are not congested. Security is improved, in particular when progressive encryption is used, because in order to decrypt some data blocks, decrypted versions of other data blocks are needed. However, the data blocks are distributed amongst a number of storage nodes, and streamed to a client along different paths, making it more difficult for an eavesdropper to acquire the information needed to decrypt at least some portions of the media content. Security is also maintained because the data, once encrypted, can be handled and distributed from the storage nodes without decryption. Also, by intelligently selecting where different portions of the stream are stored, the amount of transcoding can be reduced or eliminated in some instances. Moreover, portions of the stream can be stored where they are most likely to be needed; similarly, at any of the storage nodes, it is only necessary to store those portions likely to be needed by clients served by a particular storage node (e.g., in a portion of the network that serves only low-resolution clients, those portions of the stream associated with higher-level resolutions do not need to be stored on the nodes that serve that portion of the network). In general, embodiments in accordance with the present invention provide a fine-grained approach for distributing and storing media data that can be more finely tuned to network conditions and/or the capabilities of heterogeneous clients.

Embodiments of the present invention are thus described. While the present invention has been described in particular embodiments, it should be appreciated that the present invention should not be construed as limited by such embodiments, but rather construed according to the following claims.

What is claimed is:

1. A method of storing a stream of media data that represents an instance of media content, said method comprising:
separating scalably encoded data comprising encoded said media data into at least a first portion and a second portion;
storing said first portion of said scalably encoded data on a first node in a network; and
storing said second portion of said scalably encoded data on a second node in said network.

2. The method of claim 1 wherein said first portion comprises data from a first segment of said stream and said second portion comprises data from a second segment of said stream.

3. The method of claim 1 wherein said first portion comprises a first block of data and said second portion comprises a second block of data, said first and second blocks corresponding to a same segment of said stream, wherein a first version of said instance of media content is produced when said first block is decoded and wherein a second version of said instance of media content is produced when said second block is decoded in combination with decoding of said first block.

4. The method of claim 1 further comprising packetizing said first and second portions into scalable data packets.

5. The method of claim 4 wherein a scalable data packet comprises data from multiple non-overlapping segments of said stream.

6. The method of claim 1 wherein a portion of said scalably encoded data is redundantly stored at multiple nodes in said network.

7. The method of claim 1 wherein said first and second portions are selected according to information about said scalably encoded data.

8. The method of claim 1 wherein said first and second nodes are selected according to information about said network.

9. The method of claim 1 wherein said scalably encoded data is encrypted.

10. A system for distributing media data that describes an item of media content, said system comprising:
a processing element for separating scalably encoded data into at least a first portion and a second portion, wherein said scalably encoded data is encoded from said media data; and
a streaming element coupled to said processing element, said streaming element for sending said first portion to a first storage node in a network and said second portion to a second storage node in said network.

11. The system of claim 10 wherein said first portion comprises data from a first segment of said stream and said second portion comprises data from a second segment of said stream.

12. The system of claim 10 wherein said first portion comprises a first block of data and said second portion comprises a second block of data, said first and second blocks corresponding to a same segment of said stream, wherein a first version of said instance of media content is produced when said first block is decoded and wherein a second version of said instance of media content is produced when said second block is decoded in combination with decoding of said first block.

13. The system of claim 10 further comprising a packetizer for packetizing said first and second portions into scalable data packets, wherein a scalable data packet comprises data from multiple non-overlapping segments of said stream.

14. The system of claim 10 wherein said first and second portions are selected according to information about said scalably encoded data, wherein said information is selected from the group consisting of: spatial area features of said scalably encoded data; color component features of said scalably encoded data; resolution levels of said scalably encoded data; and quality levels of said scalably encoded data; rate distortion information about said scalably encoded data; security sensitivity of said scalably encoded data; time delivery requirements of said scalably encoded data; coding dependencies of said scalably encoded data; and encryption dependencies of said scalably encoded data.

15. The system of claim 10 wherein said first and second nodes are selected according to information about said network, wherein said information is selected from the group consisting of: bandwidth available along paths in said network; bottleneck link capacity along paths in said network; data packet delivery rates along paths in said network; data packet loss rates along paths in said network; data packet received patterns along paths in said network; data packet loss patterns along paths in said network; information quantifying time needed to traverse paths in said network; information quantifying delays associated with paths in said network; information quantifying proximity to network clients; information quantifying the number of network clients served by respective nodes in said network; distance between said first and second nodes; and information identifying characteristics of network clients served by respective nodes in said network.

16. A method of streaming media data for an instance of media content, said method comprising:
receiving a first portion of scalably encoded data from a first storage node; and
receiving a second portion of scalably encoded data from a second storage node, wherein said first and second portions are associated with the same said instance of media content.

17. The method of claim 16 wherein decoding of said first portion reconstructs a first portion of said instance of media content and decoding of said second portion reconstructs a second portion of said media content.

18. The method of claim 16 wherein decoding of said first portion reconstructs a first version of said instance of media content and decoding of said second portion in combination with decoding of said first portion reconstructs a second version of said instance of media content.

19. The method of claim 16 further comprising requesting said first portion of scalably encoded data from said first node and requesting said second portion of scalably encoded data from said second node.

20. The method of claim 16 further comprising making a request for said instance of media content, wherein said first portion and said second portion are received in response to said request.
